(19) United States
(12) Patent Application Publication
(10) Pub. No.: US 2021/0345811 A1
(43) Pub. Date: Nov. 11, 2021

(54) DUAL WALL COOKING VESSEL

(71) Applicant: Wynston Heartland, Las Vegas, NV (US)

(72) Inventor: Wynston Heartland, Las Vegas, NV (US)

(21) Appl. No.: 17/139,997

(22) Filed: Jan. 1, 2021

Related U.S. Application Data
(60) Provisional application No. 63/101,553, filed on May 5, 2020.

(51) Int. Cl. A47J 27/00; A47J 27/58

(52) U.S. Cl. CPC A47J 27/002; A47J 27/58

(57) ABSTRACT

A dual wall cooking vessel; the dual wall cooking vessel includes a cooking vessel having at least one handle, a top-rim, a base, an inner-wall, and an outer cylindrical columnar wall. The outer cylindrical columnar wall encircles the inner-wall and extends downwardly and forming a channel between the inner-wall and the outer cylindrical columnar wall. A lower perimeter of the outer cylindrical columnar wall arcing in an outward projection to form a drip-catcher. The channel is closed at the top-rim and open at the base to allow heat to travel to and within the channel. The channel is configured to retain and circulate thermal energy during use on a heated surface to provide increased thermal energy retention and distribution during use.

### CROSS-REFERENCE TO RELATED APPLICATION(S)

The present application is related to and claims priority to U.S. Provisional Patent Application No. 63/101,553 filed May 5, 2020, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of cooking vessels of existing art and more specifically relates to cooking vessels with improved heat distribution.

### RELATED ART

Cooking vessels, such as pots and frying pans, are usually manufactured of aluminum or non-ferrous materials. Typically, the cooking vessels have a flat base. With a base as flat as possible, the entire surface of the base makes contact with a stove for effective heating of the cooking vessel. Unfortunately, when a pot or pan is heated from below by open flames or an electric burner, there is a tremendous amount of heat loss around the side of the pot. There is another widespread, dangerous, injury-inducing problem associated with current cooking vessels. With ordinary pots and pans the heat rolls up the side and continues upward. If a person reaches over the cooking vessel upward moving heat can burn their arm. This problem is only exacerbated by the number of pots and pans on the stove.

Additionally, when stirring the contents of a pot or pan or serving the contents it is common to have drips and small spills. Current pots and pans allow the drips to run down their sidewalls and into a burner area of a stove. Thoroughly cleaning this area of the stove can be difficult. A suitable solution is desired.

U.S. Pat. No. 5,564,589 to Hseuh-Chien Fu relates to a pot or pan. The described pot or pan includes a more efficient flat bottom pot or pan is obtained by (a) the introduction of an initial central downward depression in the bottom plate in the order of twice the plate thickness to avoid the undesirable upward bulging of the pot bottom as a result of aging, (b) providing heat transferring fins in a spiral pattern to the bottom and helical pattern to the side wall of the pot or pan for more effective heat transfer from the stove flame to the pot or pan, and to stabilize the pot with its central depression for placement on flat surfaces, and (c) providing a detachable shielding skirt around the pot to reduce the heat loss from radiation and convection.

### SUMMARY OF THE INVENTION

In view of the foregoing disadvantages inherent in the known cooking vessel art, the present disclosure provides a novel dual wall cooking vessel. The general purpose of the present disclosure, which will be described subsequently in greater detail, is to provide a dual wall cooking vessel with improved heat distribution and retention.

A dual wall cooking vessel is disclosed herein. The dual wall cooking vessel includes a cooking vessel having at least one handle, a top-rim, a base, an inner-wall, and an outer cylindrical columnar wall being substantially cylindrical encircling the inner-wall and extending downwardly and forming a channel between the inner-wall and the outer cylindrical columnar wall. An upper perimeter of the outer cylindrical columnar wall is attached to the top-rim of the cooking vessel and a lower perimeter of the outer cylindrical columnar wall arcing in an outward projection to form a drip-catcher. The channel is closed at the top-rim and the channel is open at the base. The channel is configured to retain and circulate thermal energy during use on a heated surface to provide increased thermal energy retention and distribution during use.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a dual wall cooking vessel, constructed and operative according to the teachings of the present disclosure.

FIG. 1 is a perspective view of the dual wall cooking vessel during an ‘in-use’ condition, according to an embodiment of the disclosure.

FIG. 2 is a perspective view of the dual wall cooking vessel of FIG. 1, according to an embodiment of the present disclosure.

FIG. 3 is a top perspective view of the dual wall cooking vessel of FIG. 1, according to an embodiment of the present disclosure.

FIG. 4 is a cut away view of the dual wall cooking vessel of FIG. 1, according to an embodiment of the present disclosure.

FIG. 5 is a bottom perspective view of the dual wall cooking vessel of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a cooking vessel and more particularly to a dual wall cooking vessel as used to improve the use of cooking vessels. The dual wall cooking vessel allows for food preparation to be done faster, fuller, safer, cleaner, and with less energy.

Generally, the dual wall cooking vessel is a cooking vessel with a second, surrounding columnar wall, which allows heat radiating from the base sidewalls of this vessel to be retained and moved throughout that contained area. With this retained heat, contents of the vessel can be heated faster and throughout the entire structure, requiring less energy in the process. In addition, this surrounding columnar wall features an open channel about its lower circumference, into which spills and runoffs can be collected instead of creating any mess on the hosting stovetop. Handles may be included on an exterior plane of the surrounding columnar wall, and a lid may also be provided for application to a top plane of the cooking vessel. The dual wall cooking vessel reduces the amount of heat and steam that escapes from its sidewalls and thereby reduces the likelihood of a user burning their hands, arms and/or face in comparison to ordinary cookware.

In one embodiment, a stock pot is provided. The dual wall cooking vessel is made of stainless steel, preferably measuring ten inches in diameter by seven and a half inches in height (10″×7.5″). Encircling this stock pot, and permanently attached to its top point, is a second, outer (substantially) cylindrical columnar wall. The outer cylindrical columnar wall preferably measures eleven and a half inches in diameter by ten inches in height (11½″×10″), thus providing a half-inch (½″) gap between the second wall and the base cooking vessel. The upper perimeter of the outer cylindrical columnar wall attaches to the hosting stock pot. The lower perimeter of this second wall arcs in an outward projection to form an open-topped channel of an approximate half-inch width by one-inch height (½″×1″). A flat lid is further provided including a center-placed handle.

The dual wall cooking vessel can be made in various sizes and formats that may be packaged individually and/or as complete sets. The surrounding columnar wall of the dual wall cooking vessel may be of various greater diameters than that of its hosting cooking vessel, and creating various distances between the columnar wall and the cooking vessel. The surrounding columnar wall of the dual wall cooking vessel may also have closed attachment to the bottom plane of its hosting cooking vessel, creating a fully closed circumference between the planes of the wall and the cooking vessel. In such variation, the bottom plane may feature perforations. The dual wall cooking vessel can be made in variations in which the surrounding columnar wall is removable from its hosting cooking vessel. In such variations, the surrounding columnar wall may attach to its host by various means, such as but not limited to a trough at its top perimeter that can rest upon the top perimeter of the cooking vessel.

A method of using the dual wall cooking vessel may be as follows: placing the dual wall cooking vessel on a heating surface. After placement of the dual wall cooking vessel on a heating surface, food items may be placed within the dual wall cooking vessel and the cooking surface may then be set to a desired temperature. Heat generated from the heating surface then radiates from the base of the dual wall cooking vessel. This heat is captured by the outer cylindrical columnar wall, and then progresses upward within the space between the outer cylindrical columnar wall and inner-wall of the cooking vessel. With this additional radiation of collected heat, which transfers back to the cooking vessel, full contents of the cooking vessel are heated more fully, evenly and faster than could ordinarily be achieved. This faster cooking results in lower utility costs, and also retains the serving temperature of the food contents, as well. Should the user need to stir the contents of the dual wall cooking vessel during use, he or she can do so without any risk of scalding from escaped heat source. Should stirring or subsequent serving of contents cause any minor spills, the channel at the bottom of the secondary wall will collect the spills, preventing the detailed cleanup that would ordinarily be required.

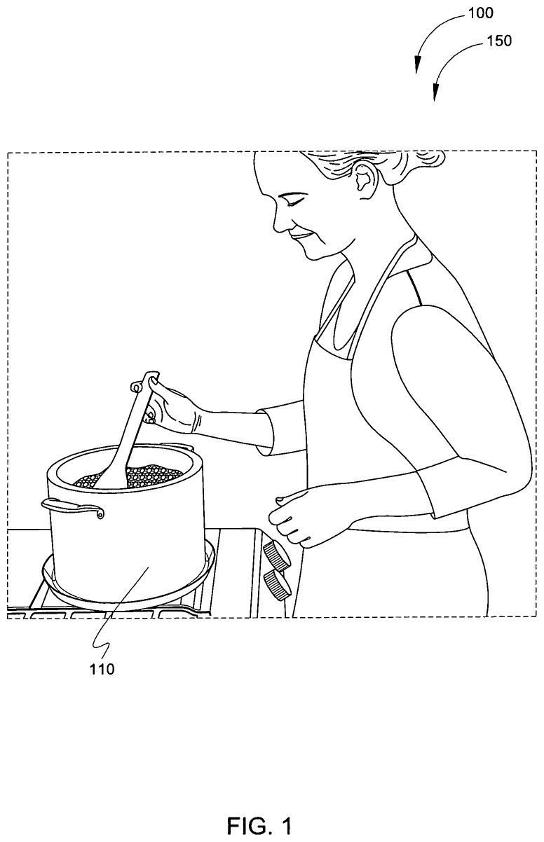

Referring now more specifically to the drawings by numerals of reference, there is shown in FIGS. 1-5, various views of a dual wall cooking vessel 100.

FIG. 1 shows the dual wall cooking vessel 100 during an ‘in-use’ condition 150, according to an embodiment of the present disclosure. The dual wall cooking vessel 100 includes a cooking vessel 110 having at least one handle 112, a top-rim 114, a base 116, an inner-wall 118, and an outer cylindrical columnar wall 120 being substantially cylindrical encircling the inner-wall 118 and extending downwardly and forming a channel 130 between the inner-wall 118 and the outer cylindrical columnar wall 120. An upper perimeter 122 of the outer cylindrical columnar wall 120 is attached to the top-rim 114 of the cooking vessel 110 and a lower perimeter 124 of the outer cylindrical columnar wall 120 arcing in an outward projection to form a drip-catcher 140. The channel 130 is closed at the top-rim 114 to substantially ensure heat from a heated surface doesn't escape the channel 130 of the cooking vessel 110, and to ensure the heat doesn't burn a user. The channel 130 is open at the base 116 to allow heat to travel to and within the channel 130. The channel 130 is configured to retain and circulate thermal energy during use on a heated surface to provide increased thermal energy retention and distribution during use.

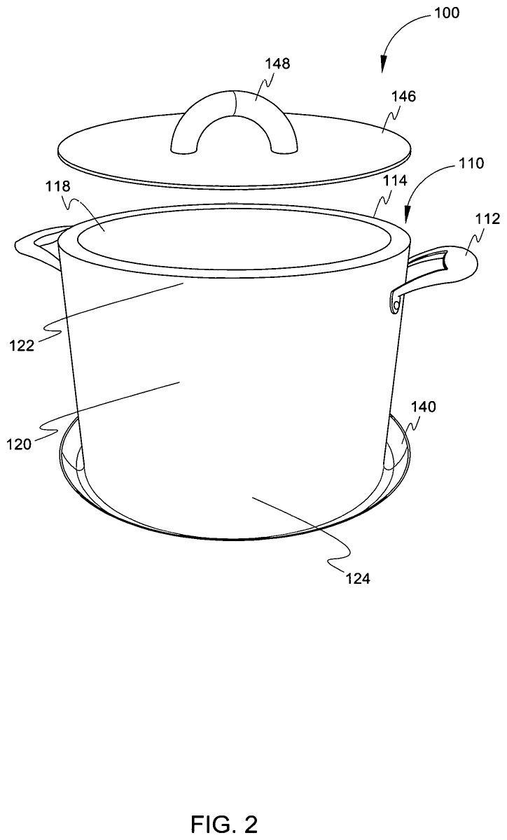

FIG. 2 shows a perspective the dual wall cooking vessel 100 of FIG. 1, according to an embodiment of the present disclosure. As above, the dual wall cooking vessel 100 may include the cooking vessel 110 comprising at least one handle 112, the top-rim 114, the base 116, the inner-wall 118, and the outer cylindrical columnar wall 120 together forming the dual wall cooking vessel 100. The base 116 of the cooking vessel 110 is preferably planar. The cooking vessel 110 may be provided with a detachable lid 146 for application to a top plane of the cooking vessel 110. The lid 146 may include a substantially planar profile. The lid 146 further comprises a lid-handle 148; the lid-handle 148 is preferably positioned at a center-point of the lid 146.

In a most preferred embodiment, the cooking vessel 110 is a pot. The pot comprises a height of approximately 7.5 inches and a diameter of approximately 10 inches. The dual wall cooking vessel 110 can be made in many varieties of cooking vessels, including but not limited to pots, pans, woks and broilers, and in various sizes in each format, including commercial-use sizes. The dual wall cooking vessel 110 may comprise various materials of applicability, including but not limited to stainless steel, copper, aluminum, ceramic and anodized aluminum. Additionally, the dual wall cooking vessel 110 may be made in varieties that feature a non-stick coating upon an interior of the cooking vessel.

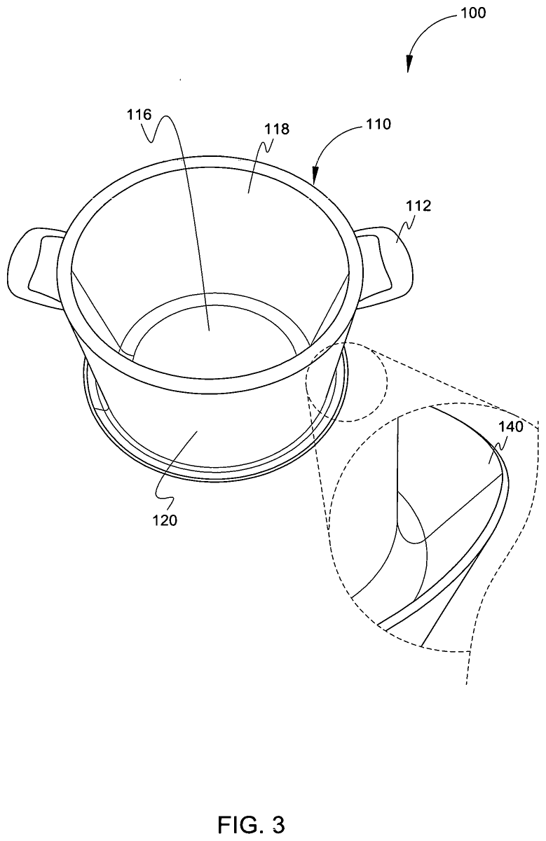

FIG. 3 is a top perspective view of the dual wall cooking vessel 100 of FIG. 1, according to an embodiment of the present disclosure. As shown in the FIGURES, the drip-catcher 140 extends along an entire the lower perimeter 124 of the outer cylindrical columnar wall 120. The drip-catcher 140 comprises an open-topped, semi-arcuate-channel configured to catch small spills that may occur when stirring and/or serving the contents of the cooking vessel 110, and thereby prevents the spills from reaching a cooking surface and therefore, makes clean up easier and faster. In a preferred embodiment, the drip-catcher 140 comprises a height of approximately 1-inch and a width of approximately 0.5 inches. The drip-catcher 140 may be of various heights and widths.

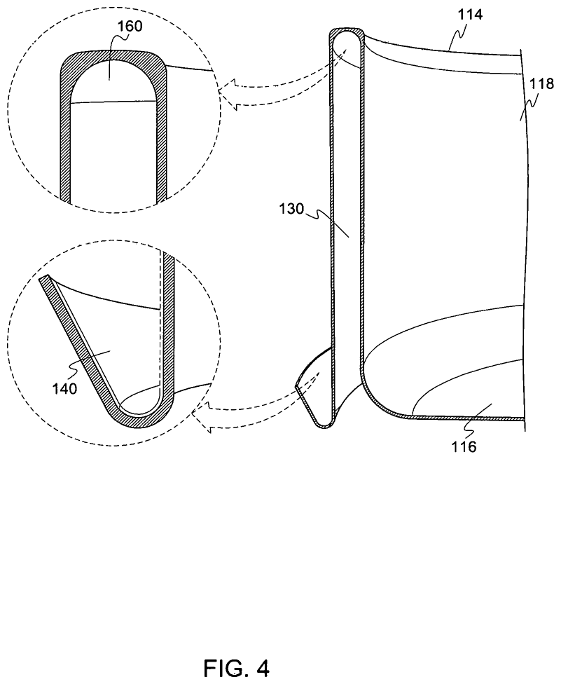

FIG. 4 is a cut away view of the dual wall cooking vessel 100 of FIG. 1, according to an embodiment of the present disclosure. As shown, the outer cylindrical columnar wall 120 is attached to the top-rim 114 of the cooking vessel at a concave radius 160. The concave radius 160 is provided for circulating heat in order to rapidly heat contents of the cooking vessel 110. In a preferred embodiment, the outer cylindrical columnar wall 120 is permanently affixed to the inner-wall 118. In other embodiments, the outer cylindrical columnar wall 120 may be removable from the inner-wall 118 or other hosting cooking vessel. The dual wall cooking vessel 100 provides a convection method to stovetop cooking, allowing heat to be distributed from along all sides of the cooking vessel 110.

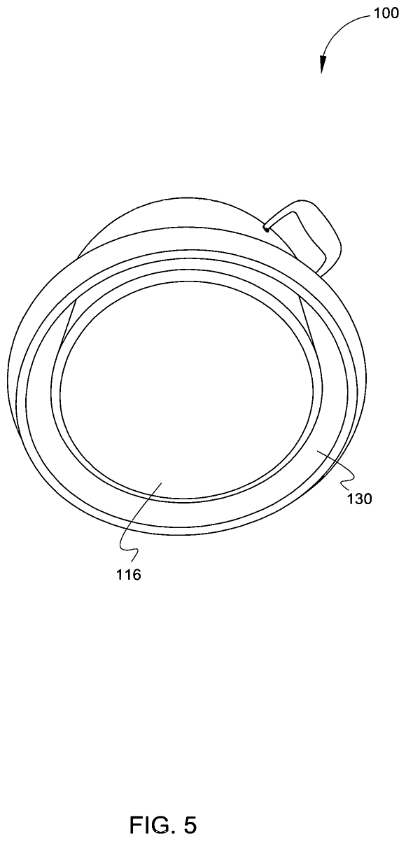

FIG. 5 is a bottom perspective view of the dual wall cooking vessel 100 of FIG. 1, according to an embodiment of the present disclosure. As illustrated in the FIGURES, the channel 130 is closed at the top-rim 114 and open at the base 116. The channel 130 formed between the inner-wall 118 and the outer cylindrical columnar wall 120 comprises a width of approximately 0.5 inches in a preferred embodiment. The outer cylindrical columnar wall 120 is configured to effectively retain heat energy emitted from the inner-wall and distribute the heat energy throughout a height of the cooking vessel 110 within the channel 130. By distributing heat throughout the channel 130 of the cooking vessel 110, the cooking vessel 110 allows contents to be more evenly heated and cooked.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A dual wall cooking vessel, the dual wall cooking vessel comprising:
a cooking vessel having;
at least one handle;
a top-rim;
a base;
an inner-wall; and
an outer cylindrical columnar wall being substantially cylindrical encircling said inner-wall and extending downwardly and forming a channel between said inner-wall and said outer cylindrical columnar wall;
wherein an upper perimeter of said outer cylindrical columnar wall is attached to said top-rim of said cooking vessel and a lower perimeter of said outer cylindrical columnar wall arcing in an outward projection to form a drip-catcher;
wherein said channel is closed at said top-rim and said channel is open at said base; and
wherein said channel is configured to retain and circulate thermal energy during use on a heated surface to provide increased thermal energy retention and distribution during use.

2. The dual wall cooking vessel of claim 1, wherein said base of said cooking vessel is planar.

3. The dual wall cooking vessel of claim 1, wherein said cooking vessel is a pot.

4. The dual wall cooking vessel of claim 1, wherein said cooking vessel comprises a stainless steel material.

5. The dual wall cooking vessel of claim 1, wherein said cooking vessel comprises a material selected from the group consisting of stainless steel, ceramic, copper, aluminum, and anodized aluminum.

6. The dual wall cooking vessel of claim 1, wherein said drip-catcher extends along an entire said lower perimeter of said outer cylindrical columnar wall.

7. The dual wall cooking vessel of claim 6, wherein said drip-catcher comprises an open-topped, semi-arcuate-channel configured to collect drips and overflow of said contents of said cooking vessel.

8. The dual wall cooking vessel of claim 7, wherein said drip-catcher comprises a height of approximately 1-inch and a width of approximately 0.5 inches.

9. The dual wall cooking vessel of claim 3, wherein said pot comprises a height of approximately 7.5 inches and a diameter of approximately 10 inches.

10. The dual wall cooking vessel of claim 1, wherein said outer cylindrical columnar wall is attached to said top-rim of said cooking vessel at a concave radius.

11. The dual wall cooking vessel of claim 1, wherein said channel formed between said inner-wall and said outer cylindrical columnar wall comprises a width of approximately 0.5 inches.

12. The dual wall cooking vessel of claim 1, wherein said outer cylindrical columnar wall is configured to effectively retain heat energy emitted from said inner-wall and distribute said heat energy throughout a height of said cooking vessel within said channel.

13. The dual wall cooking vessel of claim 1, wherein said outer cylindrical columnar wall is permanently affixed to said inner-wall.

14. The dual wall cooking vessel of claim 1, wherein said outer cylindrical columnar wall is removable from said inner-wall.

15. The dual wall cooking vessel of claim 1, wherein said cooking vessel is selected from the group consisting of a pot, a pan, a wok and a broiler.

16. The dual wall cooking vessel of claim 1, wherein said cooking vessel is further provided with a seal-attachment, said seal-attachment being configured to seal said channel between said inner-wall and said outer cylindrical columnar wall.

17. The dual wall cooking vessel of claim 1, wherein said cooking vessel further comprises a detachable lid.

18. The dual wall cooking vessel of claim 17, wherein said lid comprises a substantially planar profile.

19. The dual wall cooking vessel of claim 18, wherein said lid further comprises a lid-handle, said lid-handle being positioned at a center-point of said lid.

20. A dual wall cooking vessel, the dual wall cooking vessel comprising:
a cooking vessel having;
at least one handle;
a top-rim;
a base;
an inner-wall; and
an outer cylindrical columnar wall being substantially cylindrical encircling said inner-wall and extending downwardly and forming a channel between said inner-wall and said outer cylindrical columnar wall;
wherein said base of said cooking vessel is planar;
wherein said cooking vessel is selected from the group consisting of a pot, a pan, a wok and a broiler;
wherein said cooking vessel comprises a stainless steel material;
wherein an upper perimeter of said outer cylindrical columnar wall is attached to said top-rim of said cooking vessel and a lower perimeter of said outer cylindrical columnar wall arcing in an outward projection to form a drip-catcher;
wherein said outer cylindrical columnar wall is attached to said top-rim of said cooking vessel at a concave radius;
wherein said outer cylindrical columnar wall is permanently affixed to said inner-wall;
wherein said drip-catcher extends along an entire said lower perimeter of said outer cylindrical columnar wall;
wherein said drip-catcher comprises an open-topped, semi-arcuate-channel configured to collect drips and overflow of said contents of said cooking vessel;
wherein said channel is closed at said top-rim and said channel is open at said base;
wherein said outer cylindrical columnar wall is configured to effectively retain heat energy emitted from said inner-wall and distribute said heat energy throughout a height of said cooking vessel within said channel;
wherein said cooking vessel further comprises a detachable lid;
wherein said lid further comprises a lid-handle, said lid-handle being positioned at a center-point of said lid; and
wherein said channel is configured to retain and circulate thermal energy during use on a heated surface to provide increased thermal energy retention and distribution during use.
